(19) United States
(12) Patent Application Publication
(10) Pub. No.: US 2008/0222951 A1
(43) Pub. Date: Sep. 18, 2008

(54) Organic fiber sowing vessels and pots for seedlings and plants and making method therefor

(75) Inventors: Enrica Bargiacchi, Viadana (Mantova) (IT); Gianluca Costa, Viadana ( Mantova) (IT); Sergio Miele, Viadana (Mantova) (IT); Julio Malagarriga, Viadana (Mantova) (IT); Roberto Bertola, Viadana(Mantova) (IT)

Correspondence Address: HEDMAN & COSTIGAN P.C., 1185 AVENUE OF THE AMERICAS, NEW YORK, NY, 10036, US

(73) Assignee: SADEPAN CHIMICA S.r.l., VIADANA (MANTOVA) (IT)

(21) Appl. No.: 12/075,857

(22) Filed: Mar. 14, 2008

(30) Foreign Application Priority Data
Mar. 16, 2007 (IT) MI2007A000527

(51) Int. Cl. A01G 9/10; A01G 9/02; C05F 11/00

(52) U.S. Cl. 47/65.7; 523/123; 71/23

(57) ABSTRACT

A sowing vessel and pot for seedlings and plants, characterized in that said sowing vessel and pot are made of a fully biodegradable material.

### BACKGROUND OF THE INVENTION

The present invention relates to organic organic-fiber sowing vessels and pots for seedlings and plants, and also relates to a method for making said vessels and pots.

More specifically, the present invention relates to seedling and plant sowing vessels and pots, made of a biodegradable and not phytotoxic material, to which other components to be used as a substrate vessel for gamically and agamically propagating plants can be added.

As is known, a gamically propagating plant is a plant which is propagated sexually or through plant seeds, whereas an agamically propagating plant is a plant which is propagated through different vegetative members, such as stolons, sets, rhizomes, bulbs and so on.

Several agricultural cultivations are sown, or transplanted, or directly planted in a field, whereas other cultivations are sown or transplanted or planted at first in a protected environment, where they remain for a first portion of their growing cycle, up to a bedder or seedling stage, to be then bedded in a field or a greenhouse, where the plant will complete his growing cycle.

Modern breeding or farming methods provide to sow seeds or planting plant vegetative parts in a suitable germination substrate, for seeds, or a rooting substrate, for vegetative parts.

Such a substrate is arranged in suitable vessels, the so-called “sowing vessels” or “sowing trays”, including a plurality of lucula or wells, having different sizes and shapes, where the substrate is arranged.

Thus, as the bedding operation is carried out, each seedling will have a small substrate “bread”, for growing therein the most part of the tiny radical apparatus.

Consequently, the latter will not be subject to traumatic stresses, upon transplanting, and will be able of quickly recovering its growth, upon transferring the seedling or plant to its ultimate growing plates, that is either a growing field or a greenhouse.

Prior sowing trays are conventionally made of plastics material, such as polyethylene, or composite materials, such as paper materials, or of a plasticized or waxed or multilayered type, and/or made of a textile fiber and plastic material compounds.

In particular, foamed polystyrene sowing trays, which represent a broadly diffused type of sowing vessel, have the advantage of a comparatively high lightness and suitability for breeding systems either on a “floor support” or on a “bench support”, that is said sowing trays are directly arranged on the germinating greenhouse floor, or in raised vats, similar to the well known working “benches” and being herein sprinkled with water from the top, or by a so-called “float system” sprinkling arrangement.

The words “float system” means herein, and as it is well known, a system for growing seedlings, where the polystyrene sowing trays are caused to float in a water or nourishing solution filled vat.

Thus, the seedlings, upon sprouting, will tend to drive their radicles from the substrate held in the mentioned luculum or well to the liquid medium, therefrom they will take water and other nourishing elements.

Notwithstanding the above mentioned advantages, prior plastics material sowing trays and vessels, and, in particular, polystyrene sowing trays, are affected by a lot of drawbacks.

In fact, for phytosanitary reasons, because they are susceptible to convey fungin and bacterial disease inocula, they must be renewed at the end of each growing cycle; to achieve this used sowing trays will be sent to thermaldestruction systems or to dumps, since they, in their used status, represent a special type of waste contaminated by residues of plant protection products.

Actually, attempts to sanitize used sowing trays by using disinfectant vapors or solutions, involve a lot of operating difficulties since such a sanitizing operation would be negatively affected by the volumes and shapes of the sowing trays; moreover, this situation is further aggravated by further problems deriving from processing operations performed on said sowing trays, such as bendings, breakages, an increase of the brittleness of their material, and so on.

Thus, in addition to the problems and expenses related to a disposal of prior used sowing trays or vessels and pots, a further problem is that deriving from their use for providing industrial cultivation plants, as transplanted in outside fields, such as tomatoes, melons, tobaccos and so on.

Thus, for such a cultivation, the sowing trays, upon transplanting the plants held thereby, are conventionally left at the edge part of the field, and this would require to perform a subsequent expensive collecting operation, and convey used trays to corporate places to be disposed of.

In this connection it should be pointed out that the number of sowing trays conventionally used for a surface of an hectare, varies from 150 and 250, depending on the vegetable species being processed, each tray with an average size from 0.008 and 0.012 m³ and a density of 19+30 kg/m³.

### SUMMARY OF THE INVENTION

Accordingly, the aim of the present invention is to provide sowing vessels or trays or pots, for seedlings and plants adapted to overcome the above mentioned problems affecting the prior art and related to the requirement of disposing of, by thermo-destructive or other disposal of methods, conventional trays, while eliminating other problems and expenses related to their handling at the end of their technical-agricultural period of life, that is in a post-servicing stage.

Within the scope of the above mentioned aim, a main object of the invention is to provide a sowing vessel or tray, or pot, for seedlings and plants, which is of a biodegradable nature and can be made with individual lucula of any desired configuration and size.

Another object is to provide such a seedling and plant sowing tray and vessel-pot, overcoming any problems related to post-service handling such as collecting and conveying problems, to collect and convey used trays to a disposal of place or to thermally destruct or reuse them after a sanitizing operation, as possible.

According to one aspect of the present invention, the above mentioned aim and objects, as well as yet other objects, which will become more apparent hereinafter, are achieved by biodegradable sowing vessels or trays and pots, including any desired shape and numbers of individual lucula, which sowing vessels are made of organic fibers, in particular cellulose fibers and fibrils, either virgin or regenerated, and methylen-urea and/or methylol-urea, said methylen-urea and/or methylol-urea operating as a binding material.

As is known, methylen-urea is a condensation product of urea and formic aldehyde, if its making reaction is carried out in an acid medium, while methylol-urea is a condensation product of urea and formic aldehyde if its making reaction is carried out in an alkaline medium.

Condensation methods for both reactions are well known from several years.

Each luculum or well represents for each seedling and plant, an organic substance source, whereas methylen-urea and/or methylol-urea represent a slow releasing nitrogen source.

The thus made sowing vessel or tray can further comprise both mineral and organic components.

As mineral components, it is possible to use: mineral fertilizer, in particular methylen-urea in powder form, zeolites, rock wool, pozzolan, pumice, clay minerals, vermiculite, perlite, foamed clay, bentonite and their mixtures in any desired rate.

As organic components, it is possible to use: vegetal meals, starches, natural and artificial textile fibers, sawdust, wood fibers and powders, as well as panel industry by products, papermill by products, paper processing waste, coconut fibers, jute fibers, kenaf fibers, barks, cork, cereal straw, rice and other cereal husks, sunflower seed shells, bagasse, peat, wood waste and mixtures thereof, in all desired rates.

One of the preferred embodiments, comprises a parallelepipedal sowing vessel or tray, having a size of 600 mm (length)×up to 400 mm (width)×up to 160 mm (height) with a luculum or well number from 1 to 680 (34×20).

The luculum or well number depends on agronomic requirements of the vegetal species to be cultivated in the trays and vessels according to the invention.

For that same reason, the lucula or wells can have either an opened or closed front, including a plurality of different size holes, depending on agronomic requirements of the vegetal species being cultivated and the breeding procedure thereof.

A second embodiment comprises a sowing vessel in the form of a sowing tray with raised or elevated peripheral rims, without separating elements which, in previous embodiment, separated the inside space of the lucula or wells. In this embodiment, the tray size varies up to 600 mm (length)×up to 400 mm (width)×up to 160 mm (outer height) and up to 145 mm (inner height as measured within the tray). Even in this embodiment it is possible to either provide or not holes through the bottom of the tray.

Finally, a third embodiment comprises a flat tray, without peripheral raised or elevated rims, thereon is merely arranged or supported the cultivation sublayer, having preferably a size up to 600 mm (length)×up to 400 mm (width)×up to 160 mm (height).

In this embodiment too it is possible to either provide or not holes through the bottom portion of the tray.

The sowing vessels and pots according to the present invention provide a plurality of advantages with respect to prior art.

At first, a use of a fully biodegradable material sowing vessel or pot, prevents problems related to their post-use managing, such as: collecting, handling and sending to dumps, or related to their thermal destruction or reuse after sanitizing, as possible.

The organic fiber sowing vessels according to the invention, in addition to being biodegradable, provide, in their post-use period, a very important function, since they are partially constituted by a fertilizer which slowly releases nitrogen, with a great advantage from the cultivation standpoint, whereas the organic part (fiber) provides an organic amendment and fertilizer function.

Optionally included co-formulating mineral or organic arrays will integrate the methylen-urea activity, due to their complementary fertilizing and/or amendment action.

In particular, the sowing vessels and pots according to the present invention, allow to greatly simply and fully automatize the transplantation operations, since they must not be maintained in an undamaged condition, but can also be broken into pieces, directly on the cultivation field, and distributed through the soil, as a conventional nitrogenous fertilizer.

For further illustrating the present invention, non limitative examples are hereinbelow disclosed, which should not be considered as exhaustive of the inventive scope.

All the disclosed examples, in particular, are referred to 1000 g dry fiber, independently from the number of sowing vessels which can be made by using such an amount of fibers.

### EXAMPLE 1

1000 g of recycled cellulose, as preliminarily washed, are water pulped in a pulper device to provide a 3% dry material pulp, for a total of 33333.3 g pulp.

This dispersion is spread on a perforated belt, thereon sowing vessels or pots having desired configurations are made.

On the moving belt, the 3% pulp material loses water to provide an intermediate product including about 30% residual water (corresponding to about 70% cellulose) for a total of 1428.6 g.

Then, with the belt being continuously driven, methylen-urea is added by using a nozzle or slot film coater.

The methylen-urea herein used has a molar ratio U:F=1:0.5 and a dry residue of 60% and being catalyzed, just before use, with 20% phosphoric acid. The used ratios are as follows: 100 g liquid methylen-urea and 2 g solution phosphoric acid.

500 g of the above catalyzed mixture are sprayed on 1428.6 g of the process intermediate product, at 70% cellulose.

Immediately after the resin binding operation, the belt is caused to pass through a 150° C. oven, where catalyzed methylen-urea is dried, and cellulose further loosing water to provide an end product including 5% total residue moisture, for a total weight of 1364.3 g.

The thus made articles or manufacture are light, resistant to impacts, perfectly rigid and contain 8.7% total nitrogen, of which 7.8% is a slowly released nitrogen, whereas the remaining 0.9% is constituted by ureic nitrogen.

### EXAMPLE 2

1000 g virgin cellulose are water pulped in a pulper device to provide a 3% dry material pulp, for a total of 33333.3 g pulp.

This dispersion is spread on a perforated belt, thereon sowing vessels and pots are formed in any desired configurations and size.

On the moving belt, 3% dry material pulp loses water to provide an intermediate product including about 30% residue water (corresponding to about 70% cellulose), for a total of 1428.6 g.

Then, with the belt being continuously driven, methylol-urea is added by using a nozzle or slot film coater apparatus.

The herein used methylol-urea has a molar ratio U:F=1:0.7 and a dry residue of 70% and is catalyzed just before its use, by using a 15% ammonium phosphate (MAP) solution. The ratios are as follows: 100 g liquid methylen-urea and 10 g solution phosphate ammonium.

700 g of the above catalyzed mixture are sprayed on 1428.6 g of the process intermediated product at 70% cellulose.

Immediately after the resin binding operation, the belt is caused to pass through a 170° C. oven, where said catalyzed methylol-urea is dried and cellulose further loses water to provide an end product including 7% total residue moisture, for a total weight of 1540.5 g.

The thus made articles of manufacture are light, resistant to impacts, perfectly rigid and contain 10.0% total nitrogen, of which 8.5% is constituted by a slowly released nitrogen, whereas the remaining 1.5% is constituted by ureic nitrogen.

### EXAMPLE 3

1000 g recycled cellulose, as suitably washed, are water pulped in a pulper device to provide a 3% dry material pulp, for a total of 33333.3 g pulp.

This dispersion is spread on a perforated belt, thereon the sowing vessels and pots to be made are formed to any desired configurations and size.

On said movable belt, the 3% dry material pulp loses water to provide an intermediate product including about 30% residue water (corresponding to about 70% cellulose), for a total of 1428.6 g.

Then, with the belt being continuously driven, said methylen-urea is added by using a nozzle or slot film coater apparatus.

The herein used methylen-urea has a molar U:F=1:1.0 ratio and 65% dry material contents and being catalyzed, just before use, by 35% ammonium phosphate. The ratios are as follows: 100 g liquid ureic resin and 8 g solution ammonium sulphate.

300 g of the above catalyzed mixture are sprayed on 1428.6 g of the processing intermediate product at 70% cellulose.

Immediately after the resin binding operation, the belt is caused to pass through a 160° C. oven, where said catalyzed methylen-urea is dried and cellulose further loses water to provide an end product including 2% total residue moisture, for a total weight of 1212.6 g.

The thus made articles of manufacture are light, resistant to impacts, perfectly rigid and contain 5.5% total nitrogen fully constituted by slowly released nitrogen.

### EXAMPLE 4

According to the method disclosed in Example 1, wood waste (N=12%) is herein used instead of cellulose for making a sowing vessel or pot which, in this embodiment, has a total nitrogen contents of 17.5%, of which 8.8% is constituted by organic nitrogen, 7.8% by a slowly released nitrogen, and the remaining 0.9% by ureic nitrogen.

### EXAMPLE 5

According to the method disclosed in Example 3, is herein used a (N=12%) bark fiber for making a sowing vessel or pot having characteristics corresponding to those achieved starting from a cellulose fiber material.

### EXAMPLE 6

1000 g jute cloth or fabric are water pulped in a pulper apparatus.

The above dispersion is spread on a perforated belt, thereon the sowing vessels and pots to be made are formed to any desired configurations and size.

On the moving belt, said pulp loses water to provide an intermediate product including about 40% residue water (corresponding to about 60% jute cloth material), for a total of 1666.6 g.

Then, with the belt being continuously driven, methylen-urea is added by using a nozzle or slot film coater apparatus.

The herein used methylen-urea has a molar U:F=1:0.6 and a dry residue of 70%, and is mixed, just before use, with 35% phosphoric acid. The operating ratios or rates are as follows: 100 g liquid methylen-urea and 3 g solution phosphoric acid.

200 g of the above catalyzed mixture are sprayed on the 1666.6 g processing intermediate product at 60% jute cloth material.

Immediately after the resin binding operation, the belt is caused to pass through a 150° C. oven, where said catalyzed resin is dried, and jute further lose water to provide an end product including 2% total residue moisture, for a total weight of 1161.2 g.

The thus made end articles of manufacture are light, resistant to impacts, perfectly rigid and contain 4.0% total nitrogen, of which 3.6% is constituted by a slowly released nitrogen and the remaining 0.4% by ureic nitrogen

### EXAMPLE 7

1,000 g recycled cellulose, as properly washed, are water pulped in a pulper apparatus to provide a 1% dry material pulp, for a total of 100,000 g dispersion.

To this dispersion is added, directly from the dispersion, said methylen-urea.

With a continuously operated processing system, the methylen-urea is also continuously added.

The herein used methylen-urea has a molar ratio U:F=1:0.6 and a dry residue of 65% and being catalyzed, just before use, by 35% sulphate ammonium.

The operating ratios are 100 g liquid methylen-urea and 2 g solution ammonium sulphate.

For 1,000 g dry fiber, 1,333.3 g liquid methylen-urea are added.

Immediately after this addition, a mold is used for forming the subject article of manufacture, comprising the sowing vessel or any other desired sowing pot or vat.

The belt with the removed from the mold article of manufacture arranged thereon, is caused to pass through a 160° C. oven, where said catalyzed methylen-urea is dried and cellulose further loses water to provide an end product including 5% total residue moisture, for a total weight of 1,300 g.

In this connection, it should be apparent that the end weight will depend on the fact that only a portion of the added methylen-urea will remain on the fiber material, the remaining portion going to solution.

The thus made end articles of manufacture are light, resistant to impacts, perfectly rigid and contain 6% total nitrogen, of which 5.8% constituted by slowly released nitrogen, whereas the remaining 0.2% is constituted by ureic nitrogen.

60% total nitrogen, corresponding to 3.6%, is soluble in hot water, according to the fertilizer material activity index method.

### EXAMPLE 8

1,000 g recycled cellulose, as properly washed, are water pulped in a pulper apparatus to provide a 1% dry material pulp, for a total of 100,000 g of paste.

To this dispersion methylol-urea is directly added in said paste.

With the paste being continuously added, even said methylol-urea is continuously added.

The herein used methylol-urea has a molar ratio U:F=1:0.7 and a dry residue of 85% and is catalyzed just before use, by using 35% ammonium sulphate. The operating ratios correspond to 100 g liquid methylol-urea and 1 g solution ammonium sulphate.

For 1,000 g dry fiber, 1,500 g liquid methylol-urea are added.

Immediately after, by using a suitable mold, the herein desired articles of manufacture, comprising a sowing vessel or any other sowing pan or vat, are made.

The article of manufacture supporting belt, which supports the from the mold removed articles, is caused to pass through a 130° C. oven, where the catalyzed methylol-urea is dried and cellulose further loses water to provide an end product including 6% total residue moisture, for a total weight of 1,250 g.

In this connection, it should be apparent that the end weight will depend on the fact that only a part of the added methylol-urea will remain on the fiber material, the remaining part going to solution.

The thus made end articles of manufacture are light, resistant to impacts, perfectly rigid and contain 5% total nitrogen, of which 4.9% is a slowly released nitrogen, whereas the remaining 0.1% is ureic nitrogen.

80% total nitrogen, i.e. 4.0% thereof, is soluble in hot water, according to the fertilizer activity index method.

It has been found that the invention fully achieves the intended aim and objects.

In fact, the invention provides sowing vessels and pots or vats, for growing seedlings or plants in general, which vessels are fully made of a biodegradable material, thereby eliminating all problems related to their post-use managing such as: collecting, handling and sending to a disposal-of place, or for sending them to thermally destruction systems or for being optionally reused as possible.

The thus made sowing vessels and pots provide the possibility of simply making, in a fully mechanized manner, all the required transplantation operations, since said vessels must not be necessary maintained in an undamaged condition, but can also be broken into pieces directly on the field and spread on the soil, as a convention fertilizer.

In practicing the invention, the used materials, together with the contingent size and shapes, can be any, depending on requirements and the status of the art.

1. A sowing vessel and pot for seedlings and plants, characterized in that said sowing vessel and pot are made of a fully biodegradable material.

2. A sowing vessel and pot for seedlings and plants, according to claim 1, characterized in that said biodegradable material, comprises a part of an organic fiber and a part of methylen-urea and/or methylol-urea.

3. A sowing vessel and pot for seedlings and plants, according to claim 2, characterized in that said organic fiber comprises cellulose, in particular a virgin cellulose or a recycled cellulose.

4. A sowing vessel and pot for seedlings and plants, according to claim 2, characterized in that said organic fiber comprises 20 to 99% by dry weight of said sowing vessel and pot, preferably from 40 to 80%.

5. A sowing vessel and pot for seedlings and plants, according to claim 2, characterized in that said methylen-urea has an urea:formaldehyde molar ratio from 1:0.3 and 1:2.0 and preferably from 1:0.50 and 1:1.0 and a dry material residue from 30% to 80%.

6. A sowing vessel and pot for seedlings and plants, according to claim 2, characterized in that said methylol-urea has an urea:formaldehyde molar ratio from 1:0.3 to 1:2.0 and preferably from 1:0.50 and 1:1.0 and a dry residue from 30% to 80%.

7. A sowing vessel and pot for seedlings and plants, according to claim 1, characterized in that said methylen-urea comprises 5 to 70% by dry weight of said sowing vessel and pot, and preferably from 10 to 40%.

8. A sowing vessel and pot for seedlings and plants, according to claim 1, characterized in that said methylol-urea comprises 5 to 70% by dry weight of said sowing vessel and pot, and preferably from 10 to 40%.

9. A sowing vessel and pot for seedlings and plants, according to claim 1, characterized in that said sowing vessel and pot has a total nitrogen contents from 1 to 30%, and preferably from 5 to 20%.

10. A sowing vessel and pot for seedlings and plants, according to claim 1, characterized in that to said methylen-urea and/or methylol-urea is added a catalyzer selected from the following catalyzers: formic acid at a concentration from 5 to 50% and preferably from 10 to 25%, ammonium sulphate at a concentration from 10 to 40% and preferably from 25 to 35%; hydrosoluble monoammoiniumphosphate (MAP) at a concentration from 5 to 20% and preferably from 10 15%; hydrosoluble diammoniumphosphate (DAP) at a concentration from 10 to 40% and preferably from 20 to 30%; phosphoric acid at a concentration from 10 to 75% and preferably from 20 to 30%; sulphoric acid at a concentration from 5 to 30% and preferably from 10 to 20%; and mixtures thereof at any desired rates.

11. A sowing vessel and pot for seedlings and plants, according to claim 10, characterized in that said catalyzers comprise 0.1 to 10% by dry weight of said sowing vessel or pot, and preferably from 0.5 to 5%.

12. A sowing vessel and pot for seedlings and plants, according to claim 1, characterized in that said sowing vessel and pot comprise mineral co-formulating agents or organic matrix arrangements, for integrating an activity of said cellulose and methylen-urea and/or methylol-urea, with a complementary amendment and/or fertilizer action.

13. A sowing vessel and pot for seedlings and plants, according to claim 1, characterized in that said sowing vessel and pot comprise natural organic additives, mineral or synthetic additives and mixture thereof at any desired rates.

14. A sowing vessel and pot for seedlings and plants, according to claim 13, characterized in that said sowing vessel and pot comprise an organic additive including: vegetal meals, starches, natural and artificial textile fibers, sawdust, wood fibers and powders, as well as panel industry by-products, papermill by-products, paper processing waste, coconut fiber, jute fiber, kenaf fiber, barks, cork, cereal straw, rice and other cereal husks, sunflower seed shells, bagasse, peat, wood waste and mixtures thereof, and their mixtures at any desired rates.

15. A sowing vessel and pot for seedlings and plants, according to claim 13, characterized in that said sowing vessel and pot comprise a mineral additive including: mineral NPK, NP. NK, N fertilizers—in particular powder methylen-urea—P and K fertilizers, clay minerals, zeolites, rock wool, pozzolan, pumice, clay minerals, vermiculite, perlite, foamed clay, bentonite and mixtures thereof at any desired rates.

16. A sowing vessel and pot for seedlings and plants, according to claim 1, characterized in that said sowing vessel and pot have a parallelepiped configuration, of a size up to 600 mm in length,×up to 400 mm in width,×up to 160 mm in height, with a lucula or well number from 1 to 680 (34×20), said lucula having either a closed or an open front portion and a plurality of different size through holes.

17. A sowing vessel and pot for seedlings and plants, according to claim 1, characterized in that said sowing vessel and pot have a tray configuration including raised peripheral rims, without inner separating elements, said sowing vessel and pot having a size up to 600 mm in length,×up to 400 mm in width,×up to 160 mm in outer height, and up to 145 mm in inner height, the bottom portions of said sowing vessel and pot being either or not provided with throughgoing holes.

18. A sowing vessel and pot for seedlings and plants, according to claim 1, characterized in that said sowing vessel and pot have a flat tray configuration, without peripheral raised edges, thereon a cultivation sublayer is supported, said sowing vessel and pot having a size up to 600 mm in length,×up to 400 mm in width,×up to 160 mm in height, said sowing vessel and pot having a bottom portion either including or not throughgoing holes.

19. A sowing vessel and pot for seedlings and plants, according to claim 1, characterized in that said methylen-urea and/or methylol-urea is added to a finished vessel and pot by using a nozzle film coater apparatus.

20. A sowing vessel and pot for seedlings and plants, according to claim 1, characterized in that methylen-urea and/or methylol-urea is added directly into the starting paste of the fiber.

21. A pot for seedlings and plants, according to claim 1, characterized in that it is a flower pot.

22. A method for making sowing vessels and pots for seedlings and plants, comprising the step of using an organic fiber and methylen-urea and/or methylol-urea.

23. A method according to claim 20, characterized in that said method comprises the step of using, as a main component, an organic fiber, in particular cellulose, either virgin or fully recycled.

24. A method according to claim 20, characterized in that said organic fiber comprises from 30 to 99% by dry weight of said sowing vessel or pot, and preferably from 40 to 80%.

25. A method according to claim 20, characterized in that said method comprises the step of using, as a secondary component, methylen-urea with an urea:formaldehyde molar ratio from 1:0.3 to 1:2.0 and preferably from 1:0.50 to 1:1.0 and a dry residue from 30% to 80%.

26. A method according to claim 20, characterized in that said method comprises the step of using, as a secondary component, methylol-urea having an urea:formaldehyde molar ratio from 1:0.3 to 1:2.0 and preferably from 1:0.50 to 1:1.0 and a dry residue from 30% to 80%.

27. A method according to claim 20, characterized in that said methylen-urea comprises from 5 to 70% by dry weight of said sowing vessel or pot, and preferably from 10 to 40%.

28. A method according to claim 20, characterized in that said methylol-urea comprises from 5 to 70% by dry weight of said sowing vessel or pot, and preferably from 10 to 40%.

29. A method according to claim 20, characterized in that said sowing vessel or pot have a total nitrogen contents from 1 to 30% and preferably from 5 to 20%.

30. A method according to claim 20, characterized in that said method comprises the step of optionally adding to said methylen-urea and/or methylol-urea, a catalyzer selected from the following catalyzers: formic acid at a concentration from 5 to 50% and preferably from 20 to 25%; ammonium sulphate at a concentration from 10 to 40% and preferably from 25 to 35%; hydrosoluble monoammoniumphosphate (MAP) at a concentration from 5 to 20% and preferably from 10 to 15%; hydrosoluble diammoniumphosphate (DAP) at a concentration from 10 to 40% and preferably from 20 to 40%; phosphoric acid at a concentration from 10 to 75% and preferably from 20 to 35%; sulphuric acid at a concentration from 5 to 30% and preferably from 10 to 20% and mixtures thereof at any desired rates.

31. A method according to claim 20, characterized in that said catalyzers comprise from 0.1 to 10% by dry weight of said sowing vessel or pot, and preferably from 0.5 to 5%.

32. A method according to claim 20, characterized in that said method comprises the step of adding mineral co-formulating agents or organic matrix compounds to integrate the activities of the cellulose and methylen-urea, with a complementary amendment or fertilizer effect.

33. A method according to claim 20, characterized in that said method comprises the step of adding natural organic additives, mineral or synthetic additives and mixtures thereof at any desired rates.

34. A method according to claim 33, characterized in that said organic additive comprises vegetal meals, starches, natural and artificial textile fibers, sawdust, wood fibers and powders, as well as panel industry by products, papermill by-products, paper processing waste, coconut fibers, jute fibers, kenaf fibers, bark, cork, cereal straw, rice and other cereal husks, sunflower seed shells, bagasse, peat, wood waste and mixtures thereof, and their mixtures at any desired rates.

35. A method according to claim 20, characterized in that said mineral additive comprises: NPK, NP. NK, N mineral fertilizers (in particular powder methylen-urea), P and K fertilizers, clay minerals, zeolites, rock wool, pozzolan, pumice, clay minerals, vermiculite, perlite, foamed clay, bentonite and mixtures thereof at any desired rates.

36. A method according to claim 20, characterized in that said method comprises the step of adding to said organic fiber said methylen-urea and/or methylol-urea by using a nozzle film coater apparatus.

37. A method according to claim 20, characterized in that said method comprises the step of adding to said organic fibers, said methylen-urea and/or methylol-urea, directly in a fiber starting paste.
